(19) United States
(12) Patent Application Publication
(10) Pub. No.: US 2007/0004302 A1
(43) Pub. Date: Jan. 4, 2007

(54) Flame resistant matelasse fabrics utilizing spun and filament flame resistant yarns

(75) Inventors: Bob McKinnon, Newton, NC (US); Frank J. Land, Island Park, NY (US); Alan C. Handermann, Asheville, NC (US)

Correspondence Address: BUCHANAN, INGERSOLL & ROONEY PC, POST OFFICE BOX 1404, ALEXANDRIA, VA, 22313-1404, US

(73) Assignee: McKinnon Land LLC, Charlotte, NC (US)

(21) Appl. No.: 11/436,023

(22) Filed: May 18, 2006

Related U.S. Application Data
(60) Provisional application No. 60/681,949, filed on May 18, 2005.

(51) Int. Cl. B32B 27/12; B32B 27/04

(52) U.S. Cl. 442/136

(57) ABSTRACT

The invention relates to the use of a flame resistant (FR) three-layer double-knit fabric, also know as a matelasse fabric. The top layer is of standard non-FR face yarn, the middle layer is of a FR filler spun yarn and the bottom layer is of a FR spun yarn or FR filament yarn. This FR matelasse fabric can be used to protect a mattress, foundation, upholstery cushion, pillow, office panel, transportation seat or any other article requiring FR protection. In this invention, a matelasse fabric is formed by circular double knitting a FR spun or FR filament yarn into the bottom portion of the fabric, utilizing a heavy cotton count FR filler spun yarn for the middle layer and using conventional non-FR yarns for the top layer. The invention has particular applicability in the formation of FR mattresses and foundations that require passage of large open flame tests such as CPSC's 16 CFR Part 1633, California's Test Bulletin 603 and Test Bulletin 129 and in the formation of FR upholstered furniture that requires passage of California's Test Bulletin 133 or British Standard 5852 using the crib 5 ignition source or higher.

### BACKGROUND OF THE INVENTION

1. Field of the Invention

The invention relates to the use of a flame resistant (FR) three-layer double-knit fabric, also know as a matelasse fabric. The top layer is of standard non-FR face yarn, the middle layer is of a FR filler spun yarn and the bottom layer is of a FR spun yarn or FR filament yarn. This FR matelasse fabric can be used to protect a mattress, foundation, upholstery cushion, pillow, office panel, transportation seat or any other article requiring FR protection. In this invention, a matelasse fabric is formed by circular double knitting a FR spun or FR filament yarn into the bottom portion of the fabric, utilizing a heavy cotton count FR filler spun yarn for the middle layer and using conventional non-FR yarns for the top layer.

The invention has particular applicability in the formation of FR mattresses and foundations that require passage of large open flame tests such as California's Test Bulletin 603 and Test Bulletin 129 and in the formation of FR upholstered firniture that requires passage of California's Test Bulletin 133 or British Standard 5852 using the crib 5 ignition source or higher.

2. Description of the Related Art

It is well known in the textile industry to produce flame resistant products for use in upholstered furniture, mattresses, foundations, automotive seating, public transportation seating, aircraft seating and the like, using needlepunched, highloft, spunbond or spunlace nonwoven, conventional woven or conventional knit fabrics formed of natural or synthetic fibers, and then treating these fabrics with fire retarding chemicals. Conventional fire retarding chemicals include borate-based, halogen-based, phosphorus-based, melamine-based and/or antimony-based chemicals. Unfortunately, such treated fabrics are heavier than similar types of non-fire retardant fabrics, and have reduced wear life. Although chemically treated fabrics will self-extinguish and exhibit limited melt behavior when a flame is removed, they typically form brittle chars, shrink and crack open after exposure to a direct flame allowing the underlying materials to ignite. Another disadvantage of chemically treated fabrics are that they are not considered durable in that they can lose their flame retardant properties if exposed to water and it is also possible that the fire retardant chemical can migrate over time, causing a loss in FR performance. When fabrics made with fire retardant cotton, fire retardant polyester and other chemically treated fabrics are used in composite articles such as upholstered furniture and mattresses and foundations, these composite article are usually deemed unsuited for passing the more stringent open flame tests such as: California Test Bulletin 133 (TB133), California Test Bulletin 129 “Flammability Test Procedure for Mattresses for use in Public Buildings”, October 1992 (TB 129), California Test Bulletin 603 (TB603), and British Standard 5852-Crib 5 (BS5852) without the use of an additional flame barrier or fire retardant backcoating materials.

Some of the flame barrier fabrics currently being used with the goal to pass the more stringent open flame tests, such as TB129, TB133 and TB603 include:
1) A woven polymer coated 100% fiberglass flame barrier (Sandel® Fabric, Sandel International Inc.)
2) A woven or knit core-spun yarn based flame barrier where natural and/or synthetic fibers are wrapped around a multifilament glass and/or a spun p-aramid core yarn and then optionally treated with fire retardant chemicals and/or a coating of thermoplastic polyvinyl halide composition, such as polyvinyl chloride (Firegard® Seating Barriers, Intek; Firegard® Brand Products, Chiquola Fabrics, LLC, Alessandra FR barrier cloth, McKinnon-Land, LLC)
3) A nonwoven hydroentangled spunlace flame barrier made of 100% p-aramid (Thermablock™ Kevlar® Z-11, DuPont Company)
4) A nonwoven FR highloft barrier made from blends of inherently FR or chemically treated fibers and fibers containing halogenated monomers (Protech™ FR Highloft, Carpenter Co., Fire Resistant High Loft, Dupont, Esyntial Safe, Western Nonwovens Inc.)
   The disadvantages of the above mentioned flame barrier solutions for more stringent open-flame applications in upholstered furniture, mattress, foundations and other fiber-filled applications include:
   a) Woven flame barriers, especially when coated with fire retardant chemicals, impart a stiff “hand” to the composite article, which negatively affect the feel of the final product.
   b) Many woven, nonwoven and conventional knit flame barriers must be either laminated to the decorative fabric or double upholstered during manufacturing. This increases the number and complication of the dress cover fabrics, thereby increasing manufacturing costs.
   c) 100% fiberglass flame barriers have poor durability due to glass-to-glass abrasion.
   d) Natural fiber wrapped core-spun yarn fabrics require additional fire retardant chemical treatments and/or coatings of a thermoplastic polyvinyl halide composition, such as polyvinyl chloride to be effective in passing the more stringent open-flame tests. This negatively impacts the workplace by having to handle these chemicals and increases the exposure of chemicals to the consumer who uses the composite article.
   f) Hydroentangled nonwoven spunlace flame barriers, containing significant amounts of p-aramid fibers, which impart a yellow color to the flame barrier and negatively effect the look of the composite article, especially when used directly under white or light-colored decorative upholstery and/or mattress ticking fabrics and are negatively affected by UV light. They also are difficult to cut when manufacturing the quilt panels of mattresses or the upholstering a piece of furniture.
   g) FR highloft barrier fabric, although well suited for applications where fill power and bulk are desired characteristics, are a detriment in barrier applications where thin barrier materials are desired for increased manufacturing speed and/or aesthetic appeal.
   h) All the above described solutions have to be included in the manufacture of the composite article as an additional barrier layer, whereas a the subject of this invention can be utilized as a replacement of existing cover fabric on a mattress or upholstered article.

### SUMMARY OF THE INVENTION

To overcome or conspicuously ameliorate the disadvantages of the related art, it is an object of the present invention to provide a novel FR three-layer double-knit (matelasse) fabric that is easily applied to articles for which FR protection is desired. In its preferred usage in the present application, the term “flame resistant” means a product which helps to reduce the level of flammability of the final article to the point at which it is able to pass a large open flame composite type flammability test, such as: California Test Bulletin 129 (TB129) or California Test Bulletin 603 (TB603) for mattresses and foundations and California Test Bulletin 133 (TB 133) for upholstered furniture. The FR matelasse fabric, of the present invention, allows for the continued use of conventional fill materials such as polyester fiberfill and polyurethane foams, while still passing these stringent large open flame tests. It is understood by someone skilled in the art that FR matelasse fabrics of different constructions then mentioned specifically in this invention, can be designed and produced to pass less stringent open flame tests such California's Revised Test Bulletin 117 (TB117-draft 02/02 version) and British Standard 5852, etc.

The fabric of the present invention comprises a three layer, double-knit or woven fabric, where the top layer is comprised of non-flame resistant yarn, the middle layer is comprised of flame resistant spun yarn, and the bottom layer is comprised of a flame resistant spun yarn or filament.

### DETAILED DESCRIPTION OF THE PREFERRED EMBODIMENTS

In accordance with the first aspect of the invention, three different types of spun yarns or filament yarns are utilized in knitting a three-layer matelasse fabric. The top layer of the matelasse fabric consists of standard non-FR face yarns, such as those made from cotton, rayon, lyocell, polyesters, acrylic, nylons, wool, silk, mohair, cashmere, kenaf, jute, sisal, polyolefins, cellulose acetates, triacetate and polylactides or any combination thereof. Preferably, these top layer spun yarns range in cotton count from 20/1's to 36/1's.

The middle layer and bottom layers of the FR matelasse fabric of the present invention consists of FR spun yarns, such as those which can be made from any combination of fibers selected from the three following fiber categories. The middle and bottom layer FR spun yarns can be made by selecting one or more fibers from all three Categories or by selecting fibers one or more fibers from only Categories 2 and 3. Preferably, the middle layer FR spun yarns range in cotton count from 1/1's to 6/1's. Preferably, the bottom layer FR spun yarns range in cotton count from 8/1's to 26/1's.

Category 1 (Inherently FR Fibers)

The first category of constituent fibers suitable for incorporation in either the middle or bottom layer spun yarns include inherently flame resistant fibers such as:

Melamine fiber, which are sold under the tradename BASOFIL (McKinnon Land Moran, LLC). Melamine resin fiber used in conjunction with this invention can be produced for example by the methods described in EP-A-93 965, DE-A-23 64 091, EP-A-221 330, or EP-A-408 947 which are incorporated herein by reference. Particularly preferred melamine resin fibers include as monomer building block (A) from 90 to 100 mol % of a mixture consisting essentially from 30 to 100, preferably from 50 to 99, particularly preferably from 85 to 95, particularly from 88 to 93 mol % of melamine and from 0 to 70, preferably from 1 to 50, particularly preferably from 5 to 15, particularly from 7 to 12 mol % of a substituted melamine I or mixtures of substituted melamine I.

As further monomer building block (B), the particularly preferred melamine resin fibers include from 0 to 10, preferably from 0.1 to 9.5, particularly from 1 to 5 mol %, based on the total number of moles of monomer building blocks (A) and (B), of a phenol or a mixture of phenols.

The particularly preferred melamine resin fibers are customarily obtainable by reacting components (A) and (B) with formaldehyde or formaldehyde-supplying compounds in a molar ratio of melamines to formaldehyde within the range from 1:1.15 to 1:4.5, preferably from 1:1.8 to 1:3.0, and subsequent spinning.

Suitable substituted melamine of the general formula I 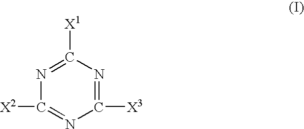
are those in which x¹, x², and x³ are each selected from the group consisting of —NH₂—NHR^{1,} and —NR¹R², although x¹, x², and x³ must not all be —NH₂, and R¹ and R² are each selected from the group consisting of hydroxy-C₂-C₁₀-alkyl, hydroxy-C₂-C₄-alkyl-(oxa-C₂-C₄-alkyl)ₙ, where n is from 1 to 5, and amino-C₂-C₁₂-alkyl.

Hydroxy-C₂-C₁₀-alkyl is preferably hydroxy-C₂-C₆-alkyl such as 2-hydroxyethyl, 3-hydroxy-n-propyl, 2-hydroxyisopropyl, 4-hydroxy-n-butyl, 5-hydroxy-n-pentyl, 6-hydroxy-n-hexyl, 3-hydroxy-2,2-dimethylpropyl, preferably hydroxy-C₂-C₄-alkyl such as 2-hydroxyethyl, 3-hydroxy-n-propyl, 2-hydroxyisopropyl and 4-hydroxy-n-butyl, particularly preferably 2-hydroxyethyl or 2-hydroxyisopropyl.

Hydroxy-C₂-C₄-alkyl-(oxa-C₂-C₄-alkyl)ₙ preferably has n from 1 to 4, particularly preferably in n=1 or 2, such as 5-hydroxy-3-oxapentyl, 5-hydroxy-3-oxa-2,5-dimethylpentyl, 5-hydroxy-3-oxa-1,4-dimethylpentyl, 5-hydroxy-3-oxa-1,2,3,4,5-tetramethylpentyl, 8-hydroxy-3,6-dioxaoctyl.

Amino-C₂-C₁₂-alkyl is preferably amino-C₂-C₈-alkyl such as 2-aminoethyl, 3-aminopropyl, 4-aminobutyl, 5-aminopentyl, 6-aminohexyl, 7-aminoheptyl, and also 8-aminooctyl, particularly preferably 2-aminoethyl and 6-aminohexyl, very particularly preferably 6-aminohexyl.

Substituted melamine particularly suitable for the invention include the following compounds:
2-hydroxyethylamino-substituted melamines such as
2-(2-hydroxyethylamino)-4,6-diamino-1,3,5-triazine,
2,4-di-(2-hydroxyethylamino)-6-amino-1,3,5-triazine,
2,4,6-tris(2-hydroxyethylamino)-1,3,5-triazine,
2-hydroxyisopropylamino-substituted melamines such as
2-(2-hydroxyisopropylamino)-4,6-diamino-1,3,5-trizaine,
2,4-di-(2-hydroxsyisopropylamino)-6-amino-1,3,5-triazine,
2,4,6-tris(2-hydroxyisopropylamino)-1,3,5-triazine,
5-hydroxy-3-oxapentylamino-substituted melamines such as
2-(5-hydroxy-3-oxapentylamino)-4,6-diamino-1,3,5-triazine,
2,4,6-tris-(5-hydroxy-3-oxapentylamino)-1,3,5-triazine,
2,4-di(5-hydroxy-3-oxapentylamino)-6-amino; 1,3,5-triazine and
also 6-aminohexylamino substituted melamines such as
2-(6-aminohexylamino)-4,6-diamino-1,3,5-triazine
2,4-di(6-amino-hexylamino)-6 amino-1,3,5-triazine
2,4,6-tris(6-aminohexylamino)-1,3,5-triazine or mixtures of these compounds, for example a mixture of 10 mol % of
2-(5-hydroxy-3-oxapentylamino)-4,6-diamino-1,3,5-triazine,
50 mol % or 2,4-di(5-hydroxy-3-oxapentylamino)-6-amino-1,3,5-triazine
and 40 mol % of 2,4,6-tris(5-hydroxy-3-oxapentylamino)-1,3,5-triazine.

Suitable phenols (B) are phenols containing one or two hydroxyl groups, such as unsubstituted phenols, phenols substituted by radicals selected from the group consisting of C₁-C₉-alkyl and hydroxyl, and also C₁-C₄-alkanes substituted by two or three phenol groups, di(hydroxyphenyl)sulfones or mixtures thereof.

Preferred phenols include phenol, 4-methylphenol, 4-tert-butylphenol, 4-n-octylphenol, 4-n-nonylphenol, pyrocatechol, resorcinol, hydroquinone, 2,2-bis(4-hydroxphenyl)propane, Bis(4-hydroxyphenyl)sulfone, particularly preferably phenol, resorcinol and 2,2-bis(4-hydroxyphenyl)propane.

Formaldehyde is generally used in the form of an aqueous solution having a concentration of, for example, from 40 to 50% by weight or in the form of compounds which supply formaldehyde in the course of the reaction with (A) and (B), for example in the form of oligomeric or polymeric formaldehyde in solid form, such as paraformaldehyde, 1,3,5-trioxane or 1,3,5,7-tetroxane.

The particularly preferred melamine resin fibers are produced by polycondensing customarily melamine, optionally substituted melamine and optionally phenol together with formaldehyde or formaldehyde supplying compounds. All the components can be present from the start or they can be reacted a little at a time and gradually while the resulting precondensates are subsequently admixed with further melamine, substituted melamine or phenol.

The polycondensation is generally carried out in a conventional manner (See EP-A-355 760, Houben-Weyl, Vol. 14/2, p. 357 ff).

The reaction temperatures used will generally be within the range from 20 to 150° C., preferably 40 to 140° C.

The reaction pressure is generally uncritical. The reaction is generally carried out within the range from 100 to 500 kPa, preferably at atmospheric pressure.

The reaction can be carried out with or without a solvent. If aqueous formaldehyde solution is used, typically no solvent is added. If formaldehyde bound in solid form is used, water is customarily used as solvent, the amount used being generally within the range from 5 to 40, preferably from 15 to 20, percent by weight, based on the total amount of monomer used.

Furthermore, the polycondensation is generally carried out within a pH range above 7. Preference is given to the pH range from 7.5 to 10.0, particularly preferably from 8 to 9.

In addition, the reaction mixture may include small amounts of customary additives such as alkali metal sulfites, for example sodium metabisulfite and sodium sulfite, alkali metal formates, for example sodium formate, alkali metal citrates, for example sodium citrate, phosphates, polyphosphates, urea, dicyandiamide or cyanamide. They can be added as pure individual compounds or as mixtures with each other, either without a solvent or as aqueous solutions, before, during, or after the condensation reaction.

Other modifiers are amines and aminoalcohol such as diethylamine, ethanolamine, diethanolamine or 2-diethylaminoethanol.

Examples of suitable fillers include fibrous or pulverulent inorganic reinforcing agents or fillers such as glass fibers, metal powders, metal salts or silicates, for example kaolin, talc, baryte, quartz or chalk, also pigments and dyes. Emulsifiers used are generally the customary nonionic, anionic, or cationic organic compounds with long-chain alkyl radicals.

The polycondensation can be carried out batchwise or continuously, for example in an extruder (See EP-A-355 760), in a conventional manner.

Fibers are produced by generally spinning the melamine resin of the present invention in a conventional manner, for example following addition of a hardener, customarily acids such as formic acid, sulfuric acid, or ammonium chloride, at room temperature in a rotospinning apparatus and subsequently completing the curing of the crude fibers in a heated atmosphere, of spinning in a heated atmosphere while at the same time evaporating the water used as solvent and curing the condensate. Such a process is described in detail in DE-A-23 64 091.

If desired, the melamine resin fibers may have added to them up to 25% preferably up to 10%, by weight of customary fillers, especially those based on silicates, such as mica, dyes, pigments, metal powders and delusterants.

Other suitable inherently flame resistant Category 1 fibers suitable for blending in the middle or bottom spun yarns of the matelasse fabric of this invention include: meta-aramids such as poly(m-phenylene isophthalamide), for example, those sold under the tradenames NOMEX by E. I. Du Pont de Nemours and Co., TEIJINCONEX by Teijin Limited and FENYLENE by Russian State Complex; para-aramids such as poly(p-phenylene terephthalamide), for example, that sold under the tradename KEVLAR by E. I. Du Pont de Nemours and Co., poly(diphenylether para-aramid), for example, that sold under the tradename TECHNORA by Teijin-Twaron Limited, and those sold under the tradenames TWARON by Teijin-Twaron Limited and FENYLENE ST (Russian State Complex); polybenzimidazole such as that sold under the tradename PBI by Hoechst Celanese Acetate LLC, polyimides, for example, those sold under the tradenames P-84 by Inspec Fibers and KAPTON by E. I. Du Pont de Nemours and Co.; polyamideimides, for example, that sold under the tradename KERMEL by Rhone-Poulenc; partially oxidized polyacrylonitriles, for example, those sold under the tradenames FORTAFIL OPF by Fortafil Fibers Inc., AVOX by Textron Inc., PYRON by Zoltek Corp., PANOX by SGL Technik, THORNEL by American Fibers and Fabrics and PYROMEX by Toho Rayon Corp.; novoloids, for example, phenol-formaldehyde novolac, for example, that sold under the tradename KYNOL by Gun Ei Chemical Industry Co.; poly(p-phenylene benzobisoxazole) (PBO), for example, that sold under the tradename ZYLON by Toyobo Co.; poly(p-phenylene benzothiazoles) (PBT); polyphenylene sulfide (PPS), for example, those sold under the tradenames RYTON by American Fibers and Fabrics, TORAY PPS by Toray Industries Inc., FORTRON by Kureha Chemical Industry Co. and PROCON by Toyobo Co.; flame retardant viscose rayons, for example, those sold under the tradenames LENZING FR by Lenzing A. G. and VISIL by Sateri Fibers Oy Finland, which is a viscose rayon that includes an aluminum silicate modified silica; polyetheretherketones (PEEK), for example, that sold under the tradename ZYEX by Zyex Ltd.; polyketones (PEK), for example, that sold under the tradename ULTRAPEK by BASF; polyetherimides (PEI), for example, that sold under the tradename ULTEM by General Electric Co.; and combinations thereof;

The most preferable inherently flame resistant fibers of Category 1, suitable for either filler yarns of the middle layer or spun yarns of the bottom layer of the matelasse fabric of the present invention, are those that are either white, off-white, transparent or translucent in color, since any other color has the possibility of negatively effecting the look of the final fabric. Of course, if color is desired in the final matelasse FR fabric, fabric can be dyed or colored appropriately.

Category 2: (Oxygen Depleting Fibers)

The second category of constituent fibers, suitable for incorporation in the middle and bottom layer spun yarns include those produced (e.g. extruded) from polymers and copolymers made with halogenated monomers. These fiber generate oxygen depleting gases which help to prevent volatile decomposition vapors of underlying or adjacent materials such as polyurethane to autoignite, help prolong the life of the inherently flame resistant char forming fibers when subjected to open flame and also help existing “surface” flame to self-extinguish. These fiber types include:
Chloropolymeric fibers, such as those containing polyvinyl chloride or polyvinylidene homopolymers and copolymers, for example, those sold under the tradenames THERMOVYL L9S & ZCS, FIBRAVYL L9F, RETRACTYL L9R, ISOVYL MPS by Rhovyl S. A; PIVIACID, Thueringische; VICLON by Kureha Chemical Industry Co., TEVIRON by Teijin Ltd., ENVILON by Toyo Chemical Co. and VICRON, made in Korea; SARAN by Pittsfield Weaving, KREHALON by Kureha Chemical Industry Co. and OMNI-SARAN by Fibrasomni, S. A. de C. V.; and modacrylics which are vinyl chloride or vinylidene chloride copolymer variants of acrylonitrile fibers, for example, those sold under the tradenames PROTEX by Kaneka and SEF by Solutia; and combinations thereof;
Fluoropolymeric fibers such as polytetrafluoroethylene (PTFE), for example, those sold under the tradenames TEFLON TFE by E. I. Du Pont de Nemours and Co., LENZING PTFE by Lenzing A. G., RASTEX by W.R. Gore and Associates, GORE-TEX by W.R. Gore and Associates, PROFILEN by Lenzing A. G. and TOYOFLON PTFE by Toray Industries Inc., poly(ethylene-chlorotrifluoroethylene) (E-CTFE), for example, those sold under the tradenames HALAR by Albany International Corp. and TOYOFLON E-TFE by Toray Industries Inc., polyvinylidene fluoride (PVDF), for example, those sold under the tradenames KYNAR by Albany International Corp. and FLORLON (Russian State Complex), polyperfluoroalkoxy (PFA), for example, those sold under the tradenames TEFLON PFA by E. I. Du Pont de Nemours and Co. and TOYOFLON PFA by Toray Industries Inc., polyfluorinated ethylene-propylene (FEP), for example, that sold under the tradename TEFLON FEP by E. I. Du Pont de Nemours and Co.; and combinations thereof;

Category 3: (Non-Flame Resistant Fibers)

A third category of constituent fibers, suitable for incorporation in the middle and bottom layer spun yarns include non-flame retardant fibers such as:
Cotton, wool, silk, mohair, cashmere, kenaf, jute, sisal and combinations thereof;
Nylons, polyesters, polyolefins, rayons, lyocells, acrylics, cellulose acetates and polylactides such as those available from Cargill Dow Polymers and combinations thereof;
Low-melt bicomponent polyesters, such as Celbond® sold by Kosa company.
Low melt copolyester fibers that have melting points lower than the melting points or degradation temperatures of the other fibers in the blends. Typical “low-melt” fibers (polyester and polyolefins) used in the industry have melting points of 100 C to 210 C. Standard polyester fiber melts at approximately 260 C.

As an alternative to utilizing a FR spun yarn in the bottom layer of the FR matelasse fabric of the present invention, as described above, an FR filament yarn can be substituted instead. FR filament yarns suitable for this bottom FR yarn substitution include: meta-aramid filament yarn such as poly(m-phenylene isophthalamide), for example, those sold under the tradenames NOMBX by E. I. Du Pont de Nemours and Co., TEIJINCONEX by Teijin Limited and FENYLENE by Russian State Complex; para-aramid filament such as poly(p-phenylene terephthalamide), for example, that sold under the tradename KEVLAR by E. I. Du Pont de Nemours and Co., poly(diphenylether para-aramid), for example, that sold under the tradename TECHNORA by Teijin-Twaron Limited, and those sold under the tradenames TWARON by Teijin-Twaron Limited and FENYLENE ST (Russian State Complex); polyimide filament, for example, those sold under the tradenames P-84 by Inspec Fibers and KAPTON by E. I. Du Pont de Nemours and Co.; polyamideimide filament, for example, that sold under the tradename KERMEL by Rhone-Poulenc; partially oxidized polyacrylonitrile filament, for example, those sold under the tradenames FORTAFIL OPF by Fortafil Fibers Inc., AVOX by Textron Inc., PYRON by Zoltek Corp., PANOX by SGL Technik, THORNEL by American Fibers and Fabrics and PYROMEX by Toho Rayon Corp.; poly(p-phenylene benzobisoxazole) (PBO) filament, for example, that sold under the tradename ZYLON by Toyobo Co; polyphenylene sulfide (PPS) filament, for example, those sold under the tradenames RYTON by American Fibers and Fabrics, TORAY PPS by Toray Industries Inc., FORTRON by Kureha Chemical Industry Co. and PROCON by Toyobo Co.; flame retardant viscose rayon filament, for example, those sold under the tradenames LENZING FR by Lenzing A. G. and VISIL by Sateri Fibers Oy Finland, which is a viscose rayon that includes an aluminum silicate modified silica; polyetheretherketones (PEEK) filament, for example, that sold under the tradename ZYEX by Zyex Ltd.; polyketones (PEK) filament, for example, that sold under the tradename ULTRAPEK by BASF; polyetherimides (PEI) filament, for example, that sold under the tradename ULTEM by General Electric Co.; and combinations thereof.

1. A three-layer double-knit or woven fabric where the top layer is comprised of non-flame resistant yarn, the middle layer is comprised of flame resistant spun yarn, and the bottom layer is comprised of a flame resistant spun yarn.

2. The fabric of claim 1, wherein the top layer yarn is comprised of fibers of cotton, rayon, lyocell, polyesters, acrylic, nylons, wool, silk, mohair, cashmere, kenaf, jute, sisal, polyolefins, cellulose acetates, triacetate and polylactides or any combination thereof.

3. The fabric of claim 1, wherein the middle layer spun yarn is comprised of melamine fibers, flame resistant rayon fibers, halogen containing polymeric fibers, or a mixture thereof.

4. The fabric of claim 3, wherein the middle layer spun yarn is comprised of a mixture of the melamine fibers and/or flame resistant rayon fibers and/or the halogen containing polymeric fibers and non-flame resistant fiber polymeric fibers.

5. The fabric of claim 1, wherein the bottom layer is comprised of flame resistant spun and/or core-spun yarns comprised of melamine fibers or halogen containing polymeric fibers and combinations thereof.

6. The fabric of claim 5, wherein the bottom layer is comprised of a mixture of the melamine fibers and/or the halogen containing polymeric fibers and a non-flame resistant fiber and combinations thereof.

7. A flame resistant barrier material useful in mattresses or foundation, upholstered furniture, top of the bed or transportation seating, which barrier material is comprised of the fabric of claim 1.

8. A three-layer, double knit or woven fabric, where the top layer is comprised of non-flame resistant yarn, the middle layer is comprised of flame resistant spun yarn, and the bottom layer is comprised of a flame resistant filament yarn.

9. The fabric of claim 8, wherein the flame resistant filament yarn of the bottom layer is comprised of an aramid filament, a polyimide filament, a polyetherimide filament, polyphenylene sulfide filament, flame resistant rayon filament or glass filament.

10. A flame resistant barrier material useful in mattresses or foundation, upholstered furniture, top of the bed or transportation seating, which barrier material is comprised of the fabric of claim 8.

11. A fabric of claim 10 wherein the barrier fabric acts as the mattress ticking or finished upholstery fabric.
